(19) United States
(12) Patent Application Publication
(10) Pub. No.: US 2021/0125067 A1
(43) Pub. Date: Apr. 29, 2021

(54) INFORMATION PROCESSING DEVICE, INFORMATION PROCESSING METHOD, AND PROGRAM

(71) Applicants: Kabushiki Kaisha Toshiba, Tokyo (JP); Toshiba Digital Solutions Corporation, Kawasaki-shi (JP)

(72) Inventors: Yukio KAMATANI, Kawasaki (JP); Hidemasa ITOU, Inagi (JP); Katsuyuki HANAI, Fuchu (JP); Mayumi YUASA, Ota (JP); Meiteki SO, Kawasaki (JP)

(73) Assignees: Kabushiki Kaisha Toshiba, Tokyo (JP); Toshiba Digital Solutions Corporation, Kawasaki-shi (JP)

(21) Appl. No.: 17/082,738

(22) Filed: Oct. 28, 2020

(30) Foreign Application Priority Data
Oct. 29, 2019 (JP) 2019-196584

(51) Int. Cl. G06N 3/08; G06K 9/62; G06F 17/18

(52) U.S. Cl. CPC G06N 3/08; G06K 9/623; G06F 17/18; G06K 9/6296; G06K 9/6262

(57) ABSTRACT

An information processing device includes a definer, a determiner, and a reinforcement learner. The definer is configured to associate a node and an edge with attributes and to define a convolution function associated with a model representing data of a graph structure representing a system structure on the basis of data regarding the graph structure. The evaluator is configured to input a state of the system into the model. The evaluator is configured to obtain, for each time step, a policy function as a probability distribution of a structural change and a state value function for reinforcement learning for a system of one or more structurally changed models which have been changed with assumable structural changes from the model for each time step. The evaluator is configured to evaluate the structural changes in the system on the basis of the policy function. The reinforcement learner is configured to perform reinforcement learning by using a reward value as a cost generated when the structural change is applied to the system, the state value function, and the model, to optimize the structural change in the system.

### BACKGROUND OF THE INVENTION

### Technical Field

Embodiments of the present invention relate to an information processing device, an information processing method, and a program.

### Related Art

In recent years, aging of social infrastructure systems has been one of the major issues. For example, in electric power systems, lots of transformer substation facilities have been aging worldwide and it is important to formulate capital investment plans. Experts have been developing solutions to the problems associated with such capital investment plans in each field. With regard to planning for social infrastructure systems, it is necessary to satisfy the requirements of large scale, diversity, and variability in some cases. However, the related art is not responsible or adaptable to changes in configurations of the social infrastructure systems.

### Patent Documents

[Patent Document 1] Japanese Unexamined Patent Application, First Publication No. 2007-80260
[Non-Patent Document 1] Masayuki NAGATA, Arisa TAKEHARA, Electric Power Distribution Facility Renewal Leveling Support Tool in which supply reliability constraints are considered—Prototype development —, Research Report R08001, Central Research Institute of Electric Power Industry, February 2009

### BRIEF DESCRIPTION OF THE DRAWINGS

FIG. 1 is a diagram illustrating an example of an evaluation electric power circuit system model.

FIG. 2 is a diagram illustrating an example of an actual system structure.

FIG. 3 is a diagram illustrating an example of a definition of a type of assumption node AN.

FIG. 4 is a diagram for explaining an example in which a facility T1* is added between nodes AN(B1) and AN(B2) in the configuration of FIG. 3.

FIG. 5 is a diagram illustrating a neural network generated from data regarding the graph structure of FIG. 4.

FIG. 6 is a block diagram of a neural network generator.

FIG. 7 is a diagram illustrating a state in which a neural network is generated from data regarding a graph structure.

FIG. 8 is a diagram for explaining a method in which a neural network generator determines a coefficient α_{i,j}.

FIG. 9 is a block diagram illustrating an example of a configuration of an information processing device according to an embodiment.

FIG. 10 is a diagram illustrating an example of mapping of convolution processing and attention processing according to the embodiment.

FIG. 11 is a diagram for explaining an example of selection management of changes performed by a meta-graph structure series management function unit according to the embodiment.

FIG. 12 is a diagram illustrating a flow of information in an example of a learning method performed by an information processing device according to a first embodiment.

FIG. 13 is a diagram for explaining an example of a candidate node processing function according to a second embodiment.

FIG. 14 is a diagram for explaining parallel value estimation in which a candidate node is utilized.

FIG. 15 is a diagram for explaining a flow of facility change plan proposal (inference) calculation according to a third embodiment.

FIG. 16 is a diagram for explaining parallel inference processing.

FIG. 17 is a diagram illustrating an example of a functional configuration of the entire inference.

FIG. 18 is a diagram illustrating an example of costs of disposal, new installation, and replacement of a facility in a facility change plan of an electric power circuit.

FIG. 19 is a diagram illustrating a learning curve of a facility change plan task of an electric power system.

FIG. 20 is a diagram illustrating an evaluation of entropy for each learning step.

FIG. 21 is a diagram illustrating a specific plan proposal in which a cumulative cost is minimized among generated plan proposals.

FIG. 22 is a diagram illustrating an example of an image displayed on a display device.

### DETAILED DESCRIPTION

Some embodiments of the present invention provide an information processing device, an information processing method, for creating proposal for changes in structure of social infrastructures.

In some embodiments, an information processing device may include, but is not limited to, a definer, a determiner, and a reinforcement learner. The definer is configured to associate a node and an edge with attributes and to define a convolution function associated with a model representing data of a graph structure representing a system structure on the basis of data regarding the graph structure. The evaluator is configured to input a state of the system into the model. The evaluator is configured to obtain, for each time step, a policy function as a probability distribution of a structural change and a state value function for reinforcement learning for a system of one or more structurally changed models which have been changed with assumable structural changes from the model for each time step. The evaluator is configured to evaluate the structural changes in the system on the basis of the policy function. The reinforcement learner is configured to perform reinforcement learning by using a reward value as a cost generated when the structural change is applied to the system, the state value function, and the model, to optimize the structural change in the system.

An information processing device, an information processing method, and a program in an embodiment will be described below with reference to the drawings. In the following description, a facility change plan will be described below as an example of processing handled by the information processing device. This embodiment is not limited to a facility change plan task for a social infrastructure system.

First, an example of an electric power circuit system will be described.

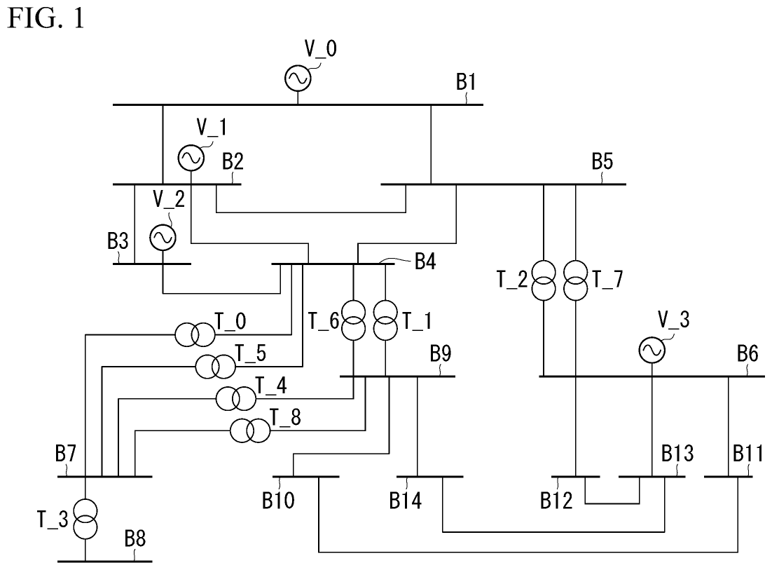

FIG. 1 is a diagram illustrating an example of an evaluation electric power circuit system model. As illustrated in FIG. 1, the evaluation electric power circuit system model includes alternating (AC) power supplies V_0 to V_3, transformers T_0 to T_8, and buses B1 to B14. The buses correspond to a concept such as “locations” to which electric power supply sources and consumers are connected.

It is assumed that a facility change mentioned herein includes selecting one of three selection options, i.e., “addition,” “disposal,” and “maintenance” for the transformer T_0 between the bus B4 and the bus B7, the transformer T_1 between the bus B4 and the bus B9, the transformer T_2 between the bus B5 and the bus B6, the transformer T_3 between the bus B7 and the bus B8, the transformer T_4 between the bus B7 and the bus B9, the transformer T_5 between the bus B4 and the bus B7, the transformer T_6 between the bus B4 and the bus B9, the transformer T_7 between the bus B5 and the bus B6, and the transformer T8 between the bus B7 and the bus B9. The three selection options are present for each of the transformers. Thus, when n (n is an integer of greater than or equal to 1) transformers are present, 3ⁿ combinations are provided. When such a facility change is considered, it is necessary to take risk costs due to an operation cost (a maintenance cost), an installation cost, a system being down, or the like of a transformer facility into account.

In the embodiment, an actual system is first expressed using a graph structure for the purpose of the facility change.

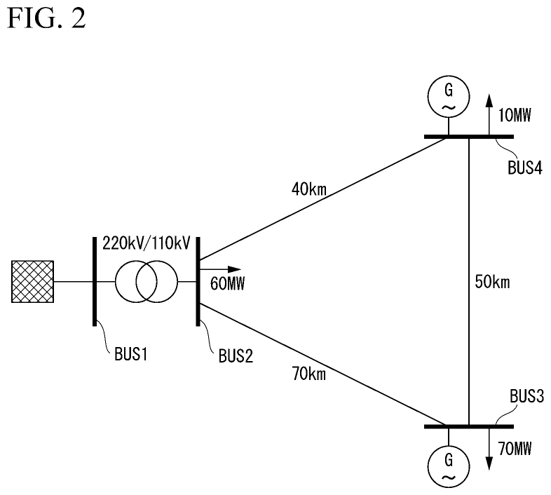

FIG. 2 is a diagram illustrating an example of an actual system structure. An example of the illustrated configuration includes the bus 1 to the bus 4. A transformer configured to transform 220 [kV] to 110 [kV] is provided between the bus 1 and the bus 2. A 60 [MW] consumer is connected to the bus 2. The bus 2 is connected to the bus 3 through a 70 [km] electric power line. An electric power generator and a 70 [MW] consumer are connected to the bus 3. The bus 2 is connected to the bus 4 through a 40 [km] electric power line and the bus 3 is connected to the bus 4 through a 50 [km] electric power line. An electric power generator and a 10 [MW] consumer are connected to the bus 4.

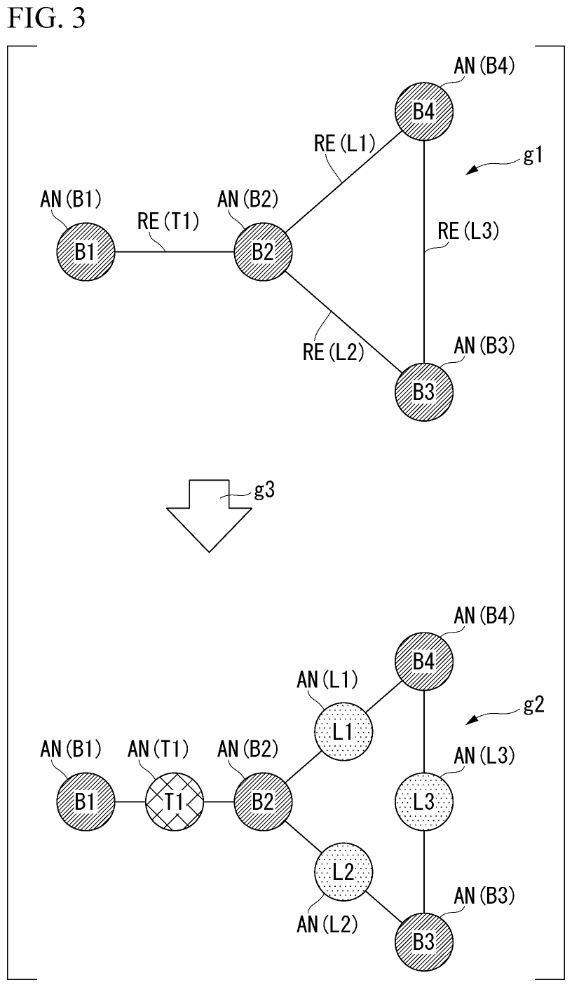

Assuming that a bus is an actual node, a transformer is an actual edge of a type “T,” and an electric power line is an actual edge of a type “L” in the configuration illustrated in FIG. 2, the configuration illustrated in FIG. 3 can be provided. FIG. 3 is a diagram illustrating an example of a definition of a type of assumption node AN. Reference symbol g1 indicates an example of the details of data regarding a graph structure and reference symbol g2 schematically indicates a state in which an actual node RN and an actual edge RE are converted into an assumption node AN. In reference symbol g1, RN(Bx) (x is an integer from 1 to 4) indicates an actual node and RE(Ly) (y is an integer from 1 to 3) and RE(T1) indicate actual edges.

In the embodiment, the data regarding the graph structure of reference symbol g1 is converted into an assumption node meta-graph such as reference symbol g2 (reference symbol g3). A method of performing the converting from the data regarding the graph structure into the assumption node meta-graph will be described later. In reference symbol g2, AN(Bx), AN(T), and AN(Ly) indicate actual nodes. In the following description, a graph such as reference symbol g2 is referred to as a “meta-graph.”

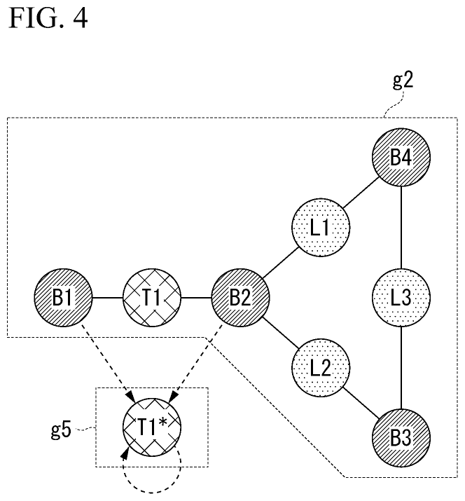

An example in which a facility T1* is added between nodes AN(B1) and AN(B2) in the configuration illustrated in FIG. 3 will be described below. FIG. 4 is a diagram for explaining the example in which the facility T1* is added between the nodes AN(B1) and AN(B2) in the configuration illustrated in FIG. 3. It is assumed that the facility T1* to be added is of the same type as a facility T1. Reference symbol g5 indicates the facility T1* to be added.

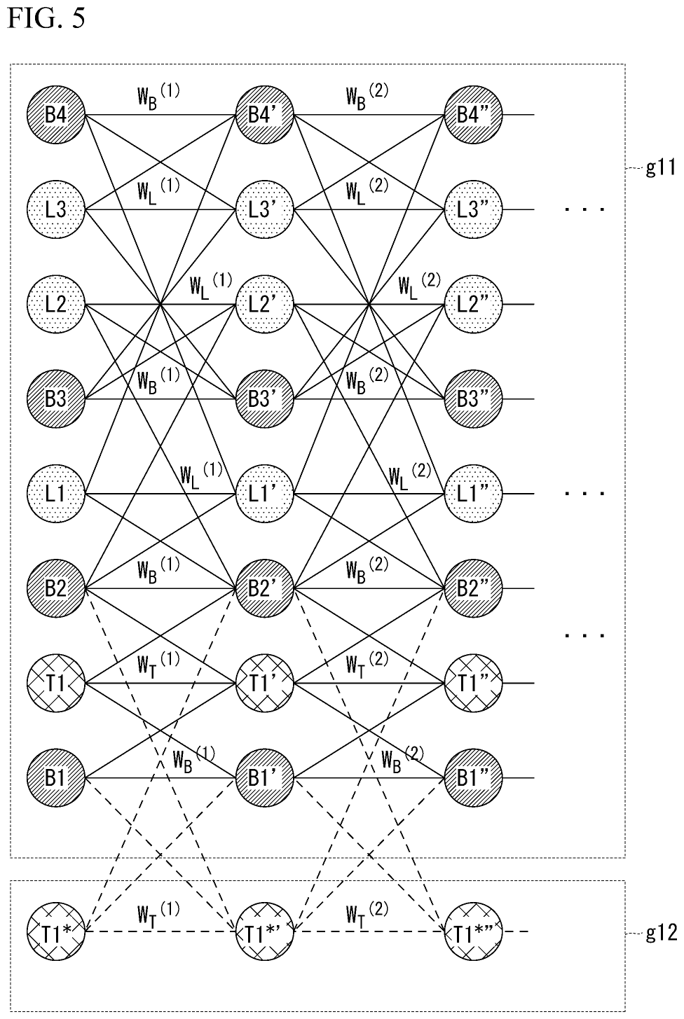

If the meta-graph illustrated in FIG. 4 is expressed by a neural network structure, the configuration illustrated in FIG. 5 can be provided. FIG. 5 is a diagram illustrating a neural network generated from the data regarding the graph structure of FIG. 4. Reference symbol g11 indicates a neural network of a system in which the facility T1* is not added and reference symbol g12 indicates a neural network associated with the facility T1* to be added. In this way, in the embodiment, a convolution function corresponding to a facility to be added is added to the network. Since the deleting of a facility is opposite to the addition of the facility, a corresponding node of the meta-node and a connection link thereof are deleted. Since the facility T1* to be added is of the same type as T1, a convolution function of the facility T1* is the same as in T1. W_{B}⁽¹⁾ and W_{B}⁽¹⁾ are propagation matrices of a first intermediate layer and W_{L}⁽²⁾ and W_{B}⁽²⁾ are propagation matrices of a second intermediate layer. A propagation matrix W_{L} is a propagation matrix of a node L from an assumption node. A propagation matrix W_{B} is a propagation matrix of a node B from an assumption node. Furthermore, for example, B4′ indicates an assumption node of the first intermediate layer and B4″ indicates an assumption node of the second intermediate layer.

In this way, a change in facility corresponds to a change in convolution function corresponding to the facility (local processing). Addition of a facility corresponds to addition of a convolution function. Disposal of a facility corresponds to deletion of a convolution function.

An example of a configuration of a neural network generator 100 will be described below.

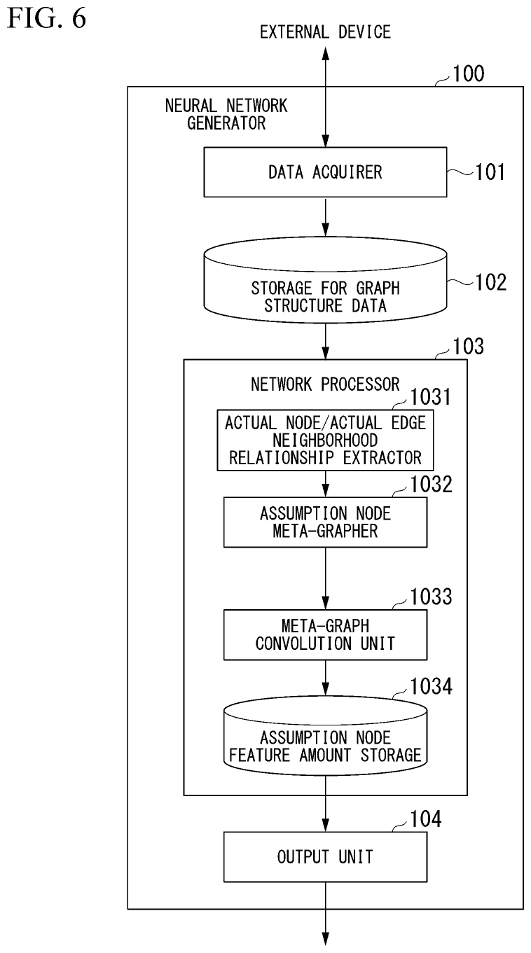

FIG. 6 is a block diagram of the neural network generator 100. The neural network generator 100 includes, for example, a data acquirer 101, a storage 102, a network processor 103, and an output unit 104.

For example, the data acquirer 101 acquires data regarding a graph structure from an external device and stores the data in the storage 102. The data acquirer 101 may acquire (read) data regarding a graph structure stored in the storage 102 in advance instead of acquiring the data regarding the graph structure from the external device or may acquire data regarding a graph structure input by a user using an input device.

The storage 102 is implemented through, for example, a random access memory (RAM), a hard disk drive (HDD), a flash memory, or the like. The data regarding the graph structure stored in the storage 102 is, for example, data in which a graph structure is expressed as each record of the actual node RN and the actual edge RE. Furthermore, the data regarding the graph structure may include a feature amount as an initial state of each actual node RN. The feature amount as the initial state of the actual node RN may be prepared as a data set different from the data regarding the graph structure.

The network processor 103 includes, for example, an actual node/actual edge neighborhood relationship extractor 1031, an assumption node meta-grapher 1032, and a meta-graph convolution unit 1033.

The actual node/actual edge neighborhood relationship extractor 1031 extracts the actual node RN and the actual edge RE in a neighborhood relationship (a connection relationship) with reference to the data regarding the graph structure. For example, the actual node/actual edge neighborhood relationship extractor 1031 may comprehensively extract the actual node RN or the actual edge RE in a neighborhood relationship (a connection relationship) for each of the actual node RN and the actual edge RE and store the extracted actual node RN or actual edge RE in the storage 102 in a form in which they are associated with each other.

The assumption node meta-grapher 1032 generates a neural network in which states of the assumption node AN are connected in a layer shape so that the actual node RN and the actual edge RE extracted through the actual node/actual edge neighborhood relationship extractor 1031 are connected. At this time, the assumption node meta-grapher 1032 determines a propagation matrix W and a coefficient α_{i,j} to satisfy the purpose of the neural network described above while following a rule based on a graph attention network described above.

For example, the meta-graph convolution unit 1033 inputs a feature amount as an initial value of the actual node RN of the assumption node AN to the neural network and derives a state (an amount of feature) of an assumption node AN of each layer. When this processing is repeatedly performed, the output unit 104 outputs the amount of feature of the assumption node AN to the outside.

An assumption node feature amount storage 1034 stores the amount of feature as the initial value of the actual node RN. The assumption node feature amount storage 1034 stores the amount of feature derived through the meta-graph convolution unit 1033.

A method of generating a neural network from data regarding a graph structure will be described below.

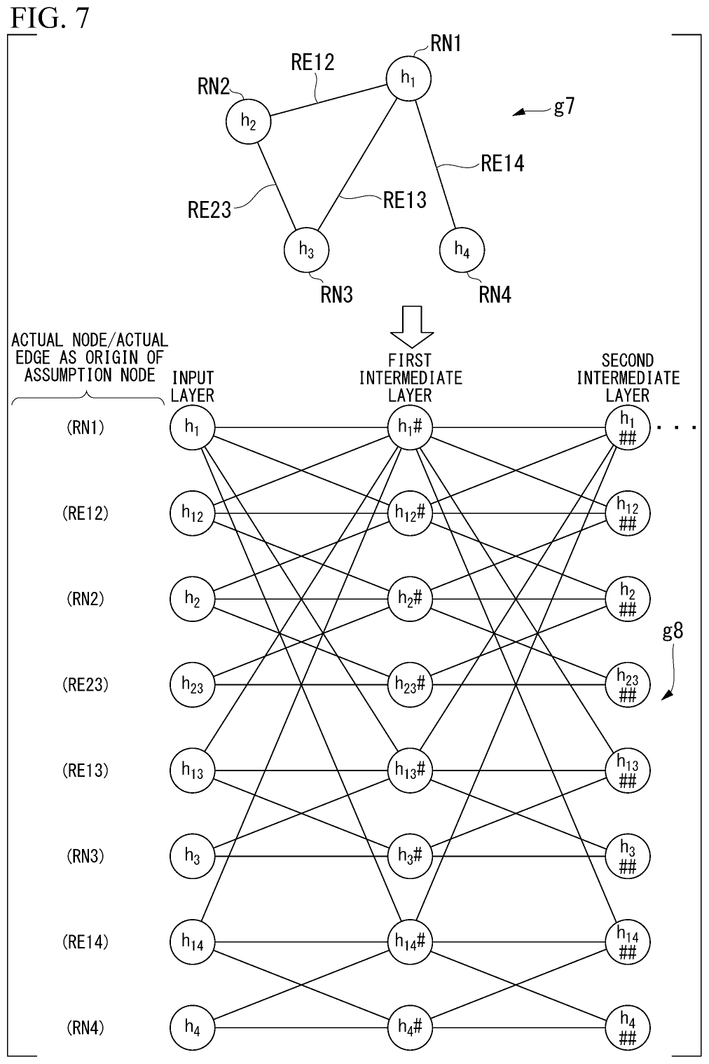

FIG. 7 is a diagram illustrating a state in which a neural network is generated from data regarding a graph structure. In FIG. 7, reference symbol g7 represents a graph structure. Reference symbol g8 represents a neural network. The neural network generator 100 generates a neural network.

As illustrated in the drawings, the neural network generator 100 sets not only the actual node RN but also the assumption node AN including the actual edge RE and generates a neural network in which an amount of feature of a k−1^{th} layer of the assumption node AN is caused to propagate to an amount of feature of a k^{th} layer of another assumption node AN in a connection relationship to the assumption node AN and the assumption node AN itself. k is a natural number of greater than or equal to 1 and a layer in which k=0 is satisfied refers to, for example, an input layer.

The neural network generator 100 determines, for example, an amount of feature of the first intermediate layer on the basis of the following Expression (1). Equation (1) corresponds to a method of calculating an amount of feature h₁# of a first intermediate layer of an assumption node (RN1).

For example, α_{1,12} is a coefficient indicating a degree of propagation between the assumption node (RN1) and an assumption node (RE12). An amount of feature h₁## of a second intermediate layer of the assumption node (RN1) is represented by the following Expression (2). Also after a third intermediate layer, amounts of feature are sequentially determined in accordance with the same rule.

[Expression 1]

h₁#=α_{1,1}·W·h₁+α_{1,12}·W·h₁₂+α_{1,13}·W·h₁₃+α_{1,14}·W·h₁₄ (1)

[Expression 2]

h₁##=α_{1,1}·W·h₁#+α_{1,12}·W·h₁₂#+α_{1,13}·W·h₁₃#+α_{1,14}·W·h₁₄# (2)

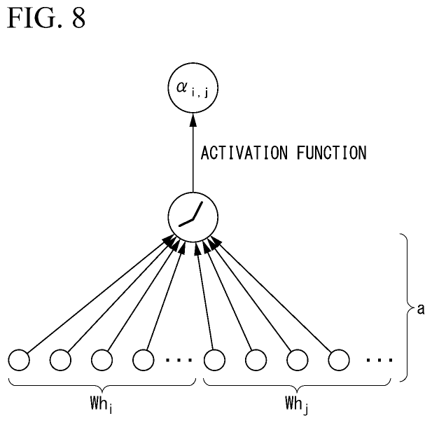

For example, the neural network generator 100 determines a coefficient α_{i,j} in accordance with a rule based on a graph attention network. FIG. 8 is a diagram for explaining a method in which the neural network generator 100 determines a coefficient α_{i,j}. The neural network generator 100 derives a coefficient α_{i,j} by inputting a vector (Whᵢ,Whⱼ) obtained by combining a vector Whᵢ obtained by multiplying an amount of feature hᵢ of an assumption node RNi which is a propagation source by a propagation matrix W with a vector Whⱼ obtained by multiplying an amount of feature hⱼ of an assumption node RNj which is a propagation destination by the propagation matrix W to an individual neural network a (attention), inputting vectors of an output layer to an activation function such as a sigmoid function, an ReLU, and a softmax function, normalizing the vectors, and adding the vectors. The individual neural network a includes parameters and the like obtained in advance for an event to be analyzed.

The neural network generator 100 determines a parameter (W, α_{i,j}) of a neural network to satisfy the purpose of the neural network while following the rule described above. The purpose of the neural network is to output a state in the future when an assumption node AN is set to a state in the present, to output an index used for evaluating a state, or to classify a state in the present.

An example of a configuration of an information processing device 1 will be described below.

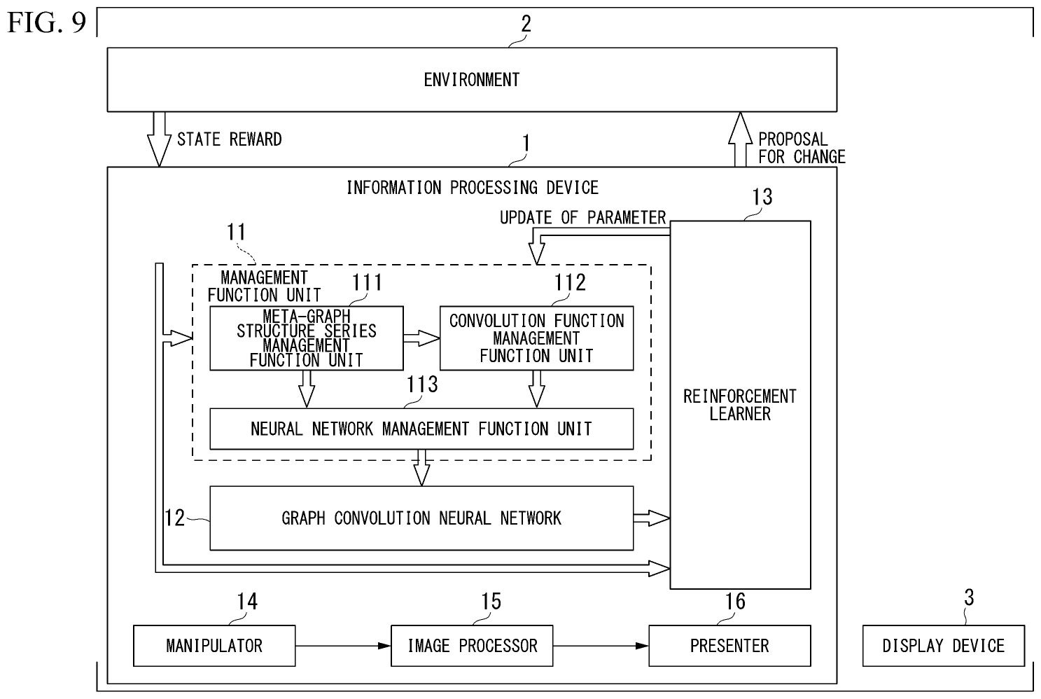

FIG. 9 is a block diagram illustrating an example of a configuration of the information processing device 1 according to the embodiment. As illustrated in FIG. 9, the information processing device 1 includes a management function unit 11, a graph convolution neural network 12, a reinforcement learner 13, a manipulator 14, an image processor 15, and a presenter 16. The management function unit 11 includes a meta-graph structure series management function unit 111, a convolution function management function unit 112, and a neural network management function unit 113. Furthermore, an environment 2 and a display device 3 are connected to the information processing device 1.

The environment 2 is, for example, a simulator, a server device, a database, a personal computer, or the like. The environment 2 receives, as an input, a change proposal as an action from the information processing device 1. The environment calculates a state in which the change is incorporated, calculates a reward, and returns the calculated results to the information processing device 1.

The display device 3 is, for example, a liquid crystal display device. The display device 3 displays an image output by the information processing device 1.

The information processing device 1 includes the functions of the neural network generator 100 described above and performs construction of a graph neural network and updating using machine learning. For example, the management function unit 11 may include the functions of the neural network generator 100. The graph neural network may be generated in advance. The information processing device 1 changes a neural network based on a change proposal acquired from the environment 2, estimates a value function (Value) value, and performs reinforcement learning processing such as temporal difference (TD) calculation based on a reward fed back from the environment. The information processing device 1 updates coefficient parameters such as a convolution function on the basis of the results of reinforcement learning. The convolution network may be a multi-layer neural network constituted by connecting convolution functions corresponding to each facility. Furthermore, each convolution function may include attention processing if necessary. A model is not limited to a neural network and may be, for example, a support vector machine or the like.

The meta-graph structure series management function unit 111 acquires a “state signal” from the environment 2; a change information signal obtained by reflecting the facility change in a part thereof. The meta-graph structure series management function unit 111 defines a meta-graph structure corresponding to a new corresponding system configuration when acquiring the change information signal and formulates a corresponding neural network structure. At this time, the meta-graph structure series management function unit 111 formulates a neural network structure in which evaluation value estimation calculation of a value function and policy function that require a change proposal is performed with high efficiency. Furthermore, the meta-graph structure series management function unit 111 constitutes a meta-graph corresponding to an actual system configuration from a convolution function set with reference to a convolution function corresponding to a change location from the convolution function management function unit 112. Moreover, the meta-graph structure series management function unit 111 performs a change of a meta-graph structure corresponding to the facility change (updating of a graph structure, setting of a “candidate node,” or the like in response to an action). The meta-graph structure series management function unit 11 performs defining and managing by associating a node and an edge with an attribute. Furthermore, the meta-graph structure series management function unit 111 includes some of the functions of the neural network generator 100 described above. In addition, the meta-graph structure series management function unit 111 is an example of the “definer.”

The convolution function management function unit 112 includes a function of defining a convolution function corresponding to a type of facility, and a function of updating a parameter of the convolution function. The convolution function management function unit 112 manages a convolution module corresponding to a partial meta-graph structure or an attention module. The convolution function management function unit 112 defines a convolution function associated with a model representing data regarding a graph structure representing a system structure on the basis of the data regarding the graph structure. The partial meta-graph structure has a library function of an individual convolution function corresponding to each facility type node or edge. The convolution function management function unit 112 updates parameters of each convolution function in a learning process. Furthermore, the convolution function management function unit 112 includes some of the functions of the neural network generator 100 described above. In addition, the convolution function management function unit 112 is an example of the “definer.”

The neural network management function unit 113 acquires a convolution module or an attention module corresponding to a neural network structure formulated by the meta-graph structure series management function unit 111 and a partial meta-graph structure managed by the convolution function management function unit 112. The neural network management function unit 113 includes a function of converting a meta-graph into a multi-layer neural network, a function of defining an output function of a neural network of a function required for reinforcement learning, and a function of updating the above-described convolution function or neural network parameter set. Functions required for reinforcement learning are, for example, reward functions, policy functions, and the like. Furthermore, an output function definition has, for example, a full-connect/multi-layer neural network and the like in which an output of the convolution function is utilized as an input. Full connect is a form in which each input is connected to all other inputs. In addition, the neural network management function unit 113 includes some of the functions of the neural network generator 100 described above. Moreover, the neural network management function unit 113 is an example of the “evaluator.”

The graph convolution neural network 12 stores, for example, an attention-type graph convolution network composed of various types of convolutions as a deep neural network.

The reinforcement learner 13 performs reinforcement learning using the graph convolution neural network constructed by the graph convolution neural network 12 and a state and a reward output by the environment. The reinforcement learner 13 changes the parameters on the basis of the results of the reinforcement learning and outputs the changed parameters to the convolution function management function unit 112. A reinforcement learning method will be described later.

The manipulator 14 includes a keyboard, a mouse, a touch panel sensor provided on the display device 3, and the like. The manipulator 14 detects the user's operation and outputs the detected operation result to the image processor 15.

The image processor 15 generates an image associated with an evaluation environment and an image associated with the evaluation result in accordance with the operation result and outputs the generated images to the presenter 16. The image associated with the evaluation environment and the image associated with the evaluation result will be described later.

The presenter 16 outputs the image output by the image processor 15 to the environment 2 and the display device 3.

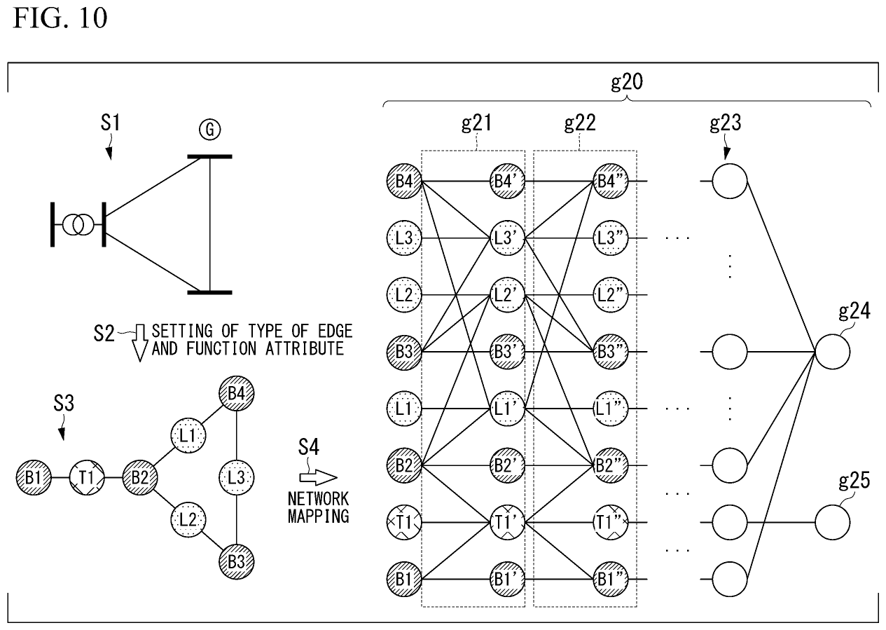

The formulation of a facility change plan series will be described below on the basis of a facility attention and convolution model. FIG. 10 is a diagram illustrating an example of mapping of convolution processing and attention processing according to this embodiment.

First, an actual system is represented by a graph structure (S1). Subsequently, a type of edge and a function attribute are set from the graph structure (S2). Subsequently, the representation is performed by a meta-graph (S3). Subsequently, network mapping is performed (S4).

Reference symbol g20 is an example of the network mapping. Reference symbol g21 indicates an edge convolution module. Reference symbol g22 indicates a graph attention module. Reference symbol g23 indicates a time series recognition module. Reference symbol g24 indicates a state value function V(s) estimation module. Reference symbol g25 indicates an action probability p(a|s) calculation module.

Here, the facility change plan task can be defined as a problem regarding reinforcement learning. That is to say, the facility change plan task can be defined as a reinforcement learning problem using the graph structure and the parameters of each node and edge (facility) as states, the addition or the deletion of a facility as an action, and the profits and the expenses to be obtained as rewards.

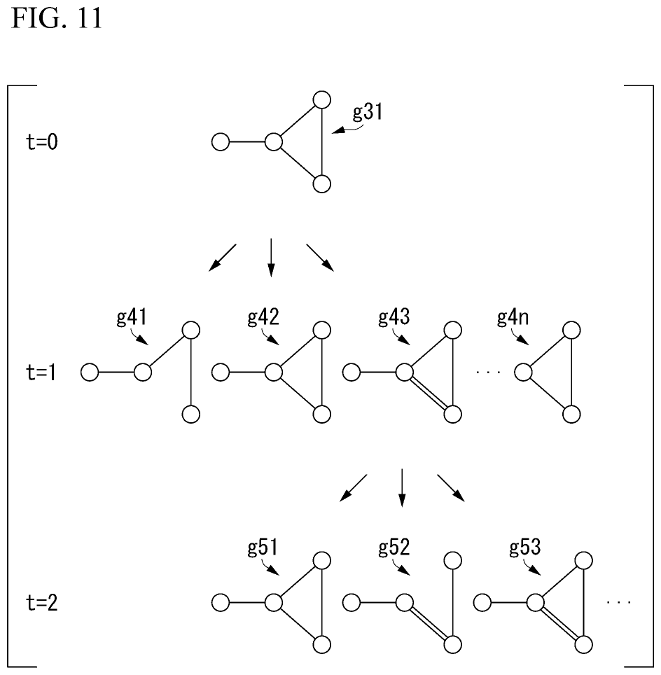

An example of selection management of changes performed by the meta-graph structure series management function unit 111 will be described. FIG. 11 is a diagram for explaining the example of the selection management of the changes performed by the meta-graph structure series management function unit 111.

Here, as an initial (t=0) state, a graph structure with 4 nodes such as Reference symbol g31 is considered.

From this state, as change candidates for the next time t=1, n (n is an integer of greater than or equal to 1) selection options such as Reference symbols g41, g42, . . . , and g4n in the middle row are considered.

For each of these selection options, a selection option at the next time t=2 is derived. Reference symbols g51, g52, . . . represent examples of selection options from a graph structure of Reference symbol g43.

In this way, a selection series is represented as a series of meta-graphs obtained by reflecting the changes, that is, a series of node changes. In the embodiment, reinforcement learning is utilized as a means for extracting a meta-graph in which a policy is satisfied from such a series.

In the embodiment, in this way, a graph neural network constituted using the information processing device 1 is associated with a system configuration on the environment side all the time. Furthermore, the information processing device 1 performs reinforcement learning using a new state S, a reward value obtained on the basis of the new state S, a value function estimated on the neural network side, and a policy function as the evaluation results on the environment side.

### First Embodiment

An example of a learning method performed by an information processing device 1 will be described. Here, although an example in which an asynchronous advantage actor-critic (A3C) is utilized as the learning method will be described, the learning method is not limited thereto. In the embodiment, reinforcement learning is utilized as a means for extracting a meta-graph in which a reward is satisfied from the selection series. Furthermore, the reinforcement learning may be, for example, deep reinforcement learning.

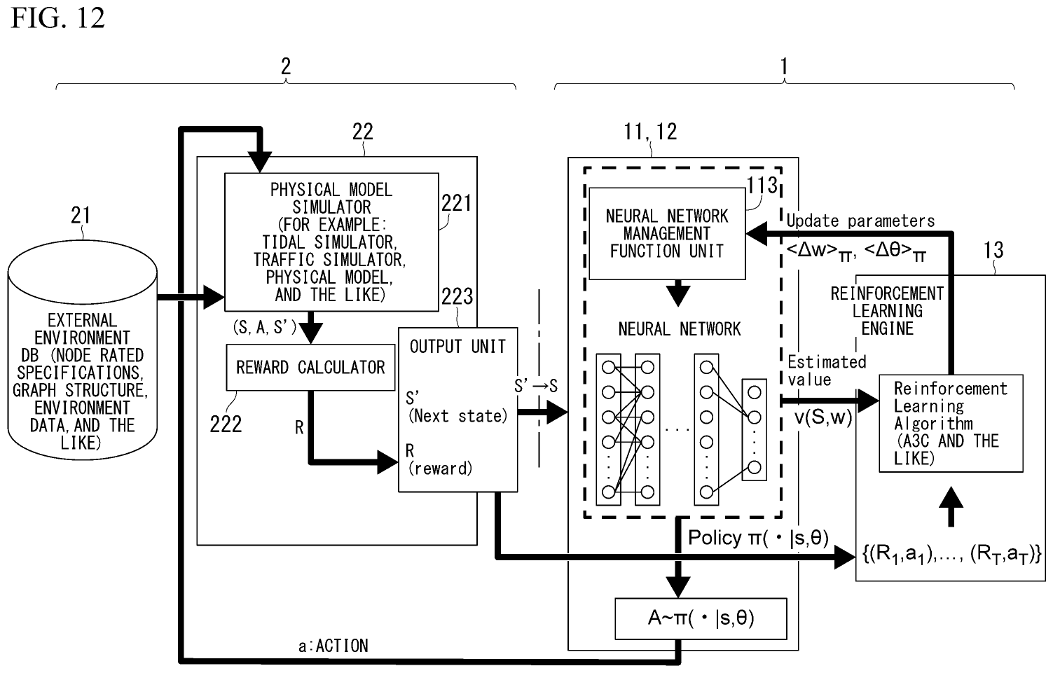

FIG. 12 is a diagram illustrating a flow of information in an example of a learning method performed by the information processing device 1 according to this embodiment. In FIG. 12, an environment 2 includes an external environment DB (a database) 21 and a system environment 22. The system environment 22 includes a physical model simulator 221, a reward calculator 222, and an output unit 223. Each type of facility is represented by a convolution function. Furthermore, a graph structure of a system is represented by a graph structure of a convolution function group.

Data stored in the external environment DB 21 corresponds to external environment data and the like. The environment data includes, for example, specifications of facility nodes, demand data in an electric power system or the like, and information and the like associated with a graph structure and corresponds to parameters which are not affected by environment states and acts and influences the determination of an action.

The physical model simulator 221 includes, for example, a tidal simulator, a traffic simulator, a physical model, a function, an equation, an emulator, an actual machine, and the like. The physical model simulator 221 acquires data stored in the external environment DB 21 if necessary and performs a simulation using the acquired data and the physical model. The physical model simulator 221 outputs the simulation results (S, A, and S′) to the reward calculator 222. S indicates a state of the system (Last State), A indicates the extracted act, and S′ indicates a new state of the system.

The reward calculator 222 calculates a reward value R using the simulation results (S, A, and S′) acquired from the physical model simulator 221. A method for calculating the reward value R will be described later. Furthermore, the reward value R is, for example, {(R₁,a₁), . . . , (R_{T},a_{T})}. Here, T indicates a facility plan examination period. Furthermore, αₚ (p is an integer from 1 to T) indicates each node. For example, a₁ indicates a first node and αₚ indicates a p^{th} node.

The output unit 223 sets a new state S′ of the system as a state S of the system and outputs the state S of the system and the reward value R to the information processing device 1.

A neural network management function unit 113 of a management function unit 11 inputs the state S of the system output by the environment 2 to a neural network stored in a graph convolution neural network 12 and obtains a policy function π(·|S,θ) and a state value function V(S, w). Here, w indicates a weight coefficient matrix (also referred to as a “convolution term”) corresponding to an attribute dimension of a node. The neural network management function unit 113 determines an act (a facility change) A in the next step using the following Expression (3).

[Expression 3]

A˜π(·|S,θ) (3)

The neural network management function unit 113 outputs the act (the facility change) A in the determined next step to the environment 2. That is to say, the policy function π(·|S,θ) receives, as an input, the state S of the system which is an examination target and outputs an act (an action). Furthermore, the neural network management function unit 113 outputs the obtained state value function V (S,w) to the reinforcement learner 13. The policy function π(·|S,θ) of selecting an action is provided as a probability distribution of an action candidate for a meta-graph structure change.

In this way, the neural network management function unit 113 inputs a state of the system to the neural network, obtains, for each time step, a policy function and a state value function required for reinforcement learning in a system of a model in which one or more changes in which a structural change which can be assumed for each time step is performed has been performed on a neural network, and evaluates a structural change of the system on the basis of the policy function. The neural network management function unit 113 may evaluate a structural change plan or a facility change plan of the system.

A state value function V(S,w) output by the management function unit 11 and a reward value R output by the environment 2 are input to the reinforcement learner 13. The reinforcement learner 13 repeatedly performs, for example, reinforcement machine learning using a machine learning method such as A3C the number of times a series of behaviors (actions) corresponds to a facility plan examination period (T) using the input state value function V(S,w) and the reward value R. The reinforcement learner 13 outputs parameters <ΔW>π and <Δθ>π obtained as a result of the reinforcement machine learning to the management function unit 11.

The convolution function management function unit 112 updates the parameters of the convolution function on the basis of the parameters output by the reinforcement learner 13.

The neural network management function unit 113 reflects the updated parameters <ΔW>π and <Δθ>π in the neural network and evaluates the neural network having the parameters reflected therein.

In the selection of the next behavior, the management function unit 11 may or may not utilize the above-described candidate node (refer to FIGS. 4 and 5).

An example of the reward function will be described below.

A first example of the reward function is (bias)-(facility installation, disposal, operation, maintenance costs). In the first example of the reward function, a respective cost may be modeled (a function) for each facility and defined as a positive reward value by subtracting the cost from the bias. The bias is a parameter which is appropriately set as a constant positive value so that a reward function value is a positive value.

A second example of the reward function is (bias)-(risk cost). In some cases physical system conditions may not be satisfied in accordance with a facility configuration. When the conditions are not satisfied, for example, a connection condition is not established, a flow is unbalanced, and an output condition is not satisfied. When such large risks occur, a negative large reward (risk) may be imposed.

A third example of the reward function may be a combination of the first and second examples of the reward function.

In this way, in this embodiment, it is possible to design various reward functions such as the first to third examples.

### Second Embodiment

In this embodiment, an example in which the next behavior is selected using a candidate node will be described.

A meta-graph structure series management function unit 111 may utilize a candidate node processing function. In this embodiment, a method in which a function in which facility node addition is likely to occur is connected to a meta-graph as a candidate as the next behavior (action) candidate and value estimation is performed on a plurality of behavior candidates in parallel will be described. A configuration of an information processing device 1 is the same as in the first embodiment.

A feature of an attention type neural network is that, even if a node is added, it is possible to perform efficient analyze and evaluation of additional effects without performing learning again by adding a learned convolution function corresponding to the node to a neural network. This is because constituent elements of a graph structure neural network based on a graph attention network are expressed as convolution functions and the whole is expressed as graph connection of a function group thereof. That is to say, when a candidate node is utilized, a classification can be performed as a neural network which expresses the entire system and a convolution function which constitutes the added node and a management can be performed.

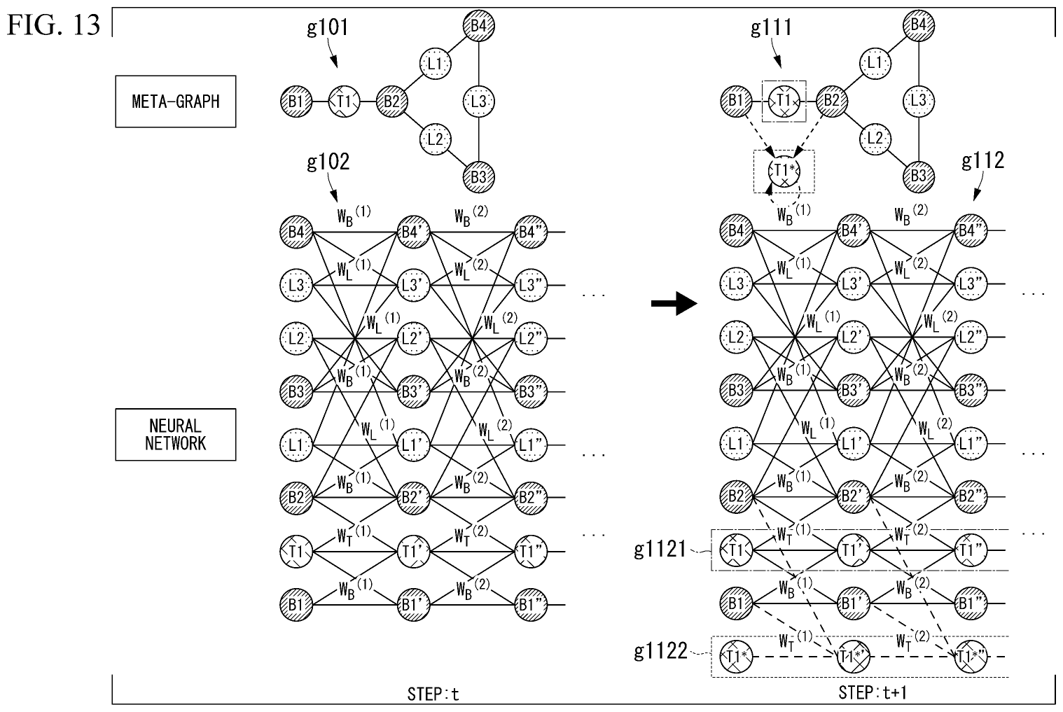

FIG. 13 is a diagram for explaining an example of a candidate node processing function according to this embodiment. Reference symbol g101 is a meta-graph in Step t and Reference symbol g102 is a neural network in Step t. Reference symbol g111 is a meta-graph in Step t+1 and Reference symbol g102 is a neural network in Step t+1.

The management function unit 11 is connected to a meta-graph as a candidate using a unidirectional connection as illustrated in Reference symbol g111 of FIG. 13 to evaluate the possibility of addition as a change candidate. Thus, the management function unit 11 handles a candidate node as a convolution function of a unidirectional connection.

The management function unit 11 is connected through a unidirectional connection from the nodes B1 and B2 to T1 such as Reference symbol g112 and performs value calculation (a policy function and a state value function) associated with T1 and T1* nodes in parallel to evaluate a value when a node T1* is added. Furthermore, Reference symbol g1121 is a reward difference for T1 and Reference symbol g1122 is a reward difference for T1* addition. It is possible to perform the estimation of a reward value of a two-dimensional behavior of reference symbol g112 in parallel.

Thus, in this embodiment, as a combination of nodes (T1,T1*), four combination, i.e., {(presence, presence), (presence, absence), (absence, presence), (absence, absence)} can be evaluate at the same time. As a result, according to this embodiment, since the evaluation can be performed in parallel, it is possible to perform calculation at high speed.

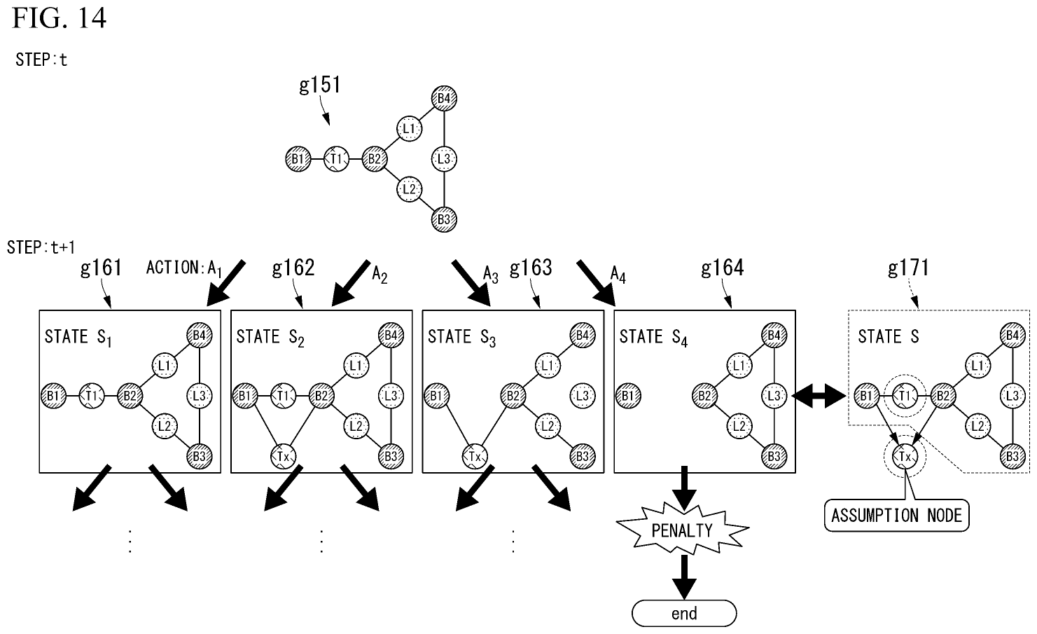

FIG. 14 is a diagram for explaining parallel value estimation in which a candidate node is utilized. Reference symbol g151 is a meta-graph of a state S in Step t. Reference symbol g161 is a meta-graph of a state S₁ (presence, absence) according to an action A₁ in Step t+1. Reference symbol g162 is a meta-graph of a state S2 (presence, presence) according to an action A₂ in Step t+1. Reference symbol g163 is a meta-graph of a state S3 (absence, presence) according to an action A₃ in Step t+1. Reference symbol g164 is a meta-graph of a state S4 (absence, absence) according to an action A₄ in Step t+1. Reference symbol g171 is a meta-graph obtained by virtually connecting a candidate node T1* to a state S.

In FIG. 14, in a system in a state S in Step t, it is assumed that an action of expansion or maintenance can be selected for nodes between B1 and B2. Under this condition, the management function unit 11 determines a selection option on the basis of the details of any selection option in which a high reward is obtained.

Here, in a case of S4 (absence, absence) among the four combinations, B1 and B2 are systematically disconnected and cannot be established as a system. In this case, the management function unit 11 causes a large risk cost (penalty) to incur. Furthermore, in this case, the management function unit 11 performs reinforcement learning in parallel for each of the states S1 to S4 on the basis of a value function value and a policy function from the neural network.

### Third Embodiment

In this embodiment, an example in which parallel processing of a process of sampling a plan series proposal is performed will be described. A configuration of the information processing device 1 is the same as in the first embodiment.

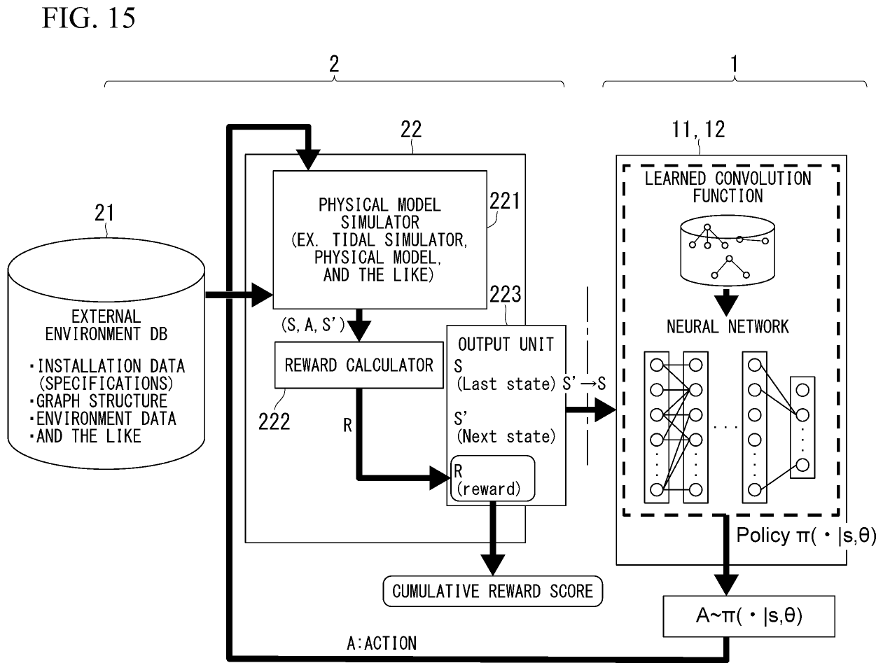

FIG. 15 is a diagram for explaining a flow of facility change plan proposal (inference) calculation according to this embodiment. FIG. 15 illustrates a main calculation process and signal flow in which a facility change plan (change series) proposal in the case of external environment data different from learning is created using a policy function acquired through an A3C learning function.

The information processing device 1 samples a plan proposal using a convolution function for each acquired facility. Furthermore, the information processing device 1 outputs plan proposals, for example, in the order of cumulative scores. The order of cumulative scores is, for example, the order of lower costs and the like.

The external environment DB 21 stores, for example, demand data in an electric power system, data relating to facility specifications, an external environment data set different from learning data such as a graph structure of a system, and the like.

The policy function is constituted using a graph neural network constituted using a learned convolution function (a learned parameter: On).

An action (a facility node change) in the next step is determined using the following Expression (4) using a state S of the system as an input.

[Expression 4]

A˜π(·|S,θπ) (4)

The management function unit 11 extracts a policy using Expression (4) on the basis of a policy function (a probability distribution for each behavior) according to a state. The management function unit 11 inputs the extracted action A to a system environment and calculates a new state S′ and a new value R associated therewith. The new state S′ is used as an input used for determining the next step. Rewards are accumulated over an examination period. The management function unit 11 repeatedly performs this operation for the number of steps corresponding to the examination period and obtains each cumulative reward score (G).

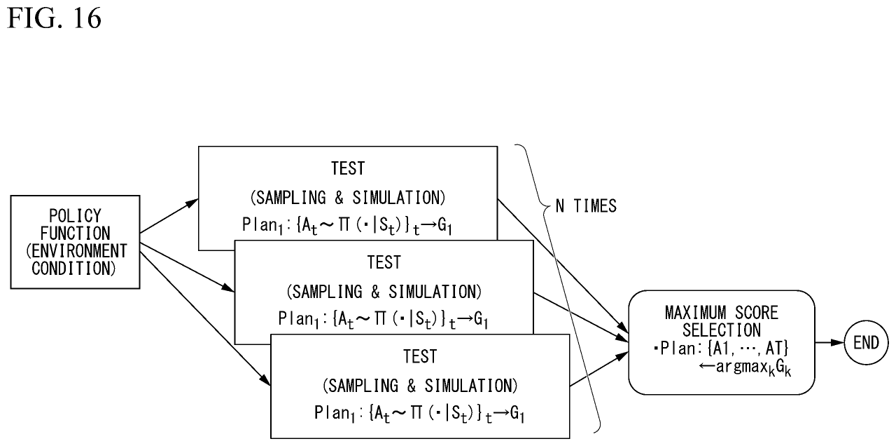

FIG. 16 is a diagram for explaining parallel inference processing.

A series of change plan series throughout an examination period corresponds to one facility change plan. A cumulative reward score corresponding to this plan is obtained. A set of combinations of a plan proposal obtained in this way and a score thereof is a plan proposal candidate set.

First, the management function unit 11 samples a plan (action series {at}t) from a policy function acquired through learning for each episode and obtains a score.

Subsequently, the management function unit 11 performs selection, for example, using an argmax function and extracts a plan {A1, . . . , AT} corresponding to the largest test among a G value of each trial (test) result. The management function unit 11 can also extract a higher-level plan.

According to this embodiment, processes of sampling each plan series proposal (N times in FIG. 16) can be process in parallel.

In order to process policy functions in parallel, standardization at an output layer is required. For the purpose of the standardization, for example, the following Expression (5) is used.

$$\begin{matrix}[ Expression 5 ] & \\ π ( a \vert {s}_{t} , θ ) = \frac{exp ( h ( {s}_{t} , a , θ ) )}{{\sum }_{h} exp ( h ( {s}_{t} , b , θ ) )} & ( 5 )\end{matrix}$$

In Expression (5), a preference function is a product π(sₜ,a,θ) of a coefficient θ and a vector x for a target output node.

Here, a case in which a multidimensional behavior (action) is handled will be described.

If an action space is a two-dimensional space, a=(a₁,a₂) is set, a is considered as a direct product of the two spaces, and a can be expressed as the following Expression (6). a₁ is a first node and a₂ is a second node.

[Expression 6]

h(sₜ,a,θ)=h(sₜ,a₁,θ)+h(sₜ,a₂,θ) (6)

That is to say, preference function may perform calculation and addition for individual spaces. In this way, individual preference functions can perform calculation in parallel if a state Sₜ of the underlying system is the same.

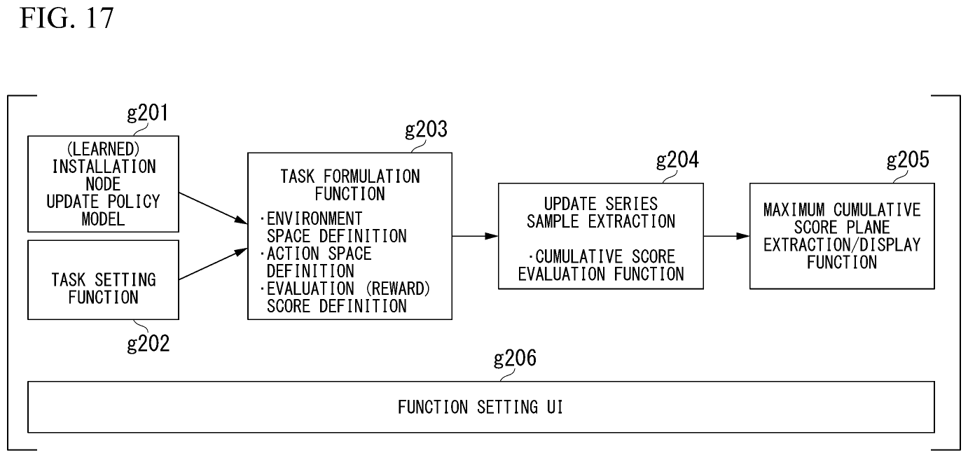

FIG. 17 is a diagram illustrating an example of a functional configuration of the entire inference. A flow of the calculation process is illustrated in FIG. 15 described above.

A facility node change policy model g201 corresponds to a learned policy function and shows an action selection probability distribution for each step in which learning has been performed in the above process.

A task setting function g202 corresponds to a task definition and a setting function such as an initial system configuration, initialization of each node parameter, external environment data, test data, and a cost model.

A task formulation function g203 includes a task defined through the task setting function, a function examination period (an episode) in which a learned policy function used as an update policy model is associated with the formulation of reinforcement learning, a policy (minimizing or leveling of a cumulative cost), an action space, an environment state space, evaluation score function formulation (a definition), and the like.

A change series sample extraction/cumulative score evaluation function g204 generates a required number of action series from a learned policy function in the defined environment and an agent environment and utilizes the action series as samples.

An optimum cumulative score plane/display function g205 selects a sample with an optimum score from a sample set or presents the samples in the order of the scores.

A function setting UT g206 is a user interface in which setting of each function unit is performed.

A specific calculation example of a facility change plan proposal will be described below.

Here, an example in which the method of the embodiment is applied to the follow tasks will be described. As the evaluation electric power circuit system model, IEEE Case 14 (Electrical Engineering, U. of Washington) shown in FIG. 1 is used.

A task is to search for a plan proposal having the lowest cumulative cost in a facility update series with a series of 30 steps. In an initial state, as illustrated in FIG. 1, a total of nine transformers (T_x) with the same specifications are provided between the buses. As illustrated in FIG. 1, as conditions, one among three actions, i.e., “addition,” “disposal,” the expression “as it is” can be selected for each node for each step for the transformers between the buses B5 and B6, B4 and B9, B7 and B9, and B4 and B7. That is to say, behavior spaces, i.e., 3×3×3×3=81 are present.

The cost to be considered is an installation cost for each facility node of the transformer and a cost according to the passage of time and a load power value and a large penalty value is imposed as a cost if the conditions for establishing the environment become difficult due to the facility change. The conditions for establishing the environment are, for example, a power flow balance and the like.

The points of the task are as follows.

I. Series system model; IEEE Case 14
II. Task; a facility change plan of new installation and deletion of a transformer of IEEE Case 14 is established so that the minimum cost is obtained over a planning period (30 updating opportunities).

### III. Conditions;

III-1. An initial state: a transformer (V_x) with the same specifications is installed between buses.

III-2: An operation cost of each transformer facility is the (weighted) sum of the following three types of costs (an installation cost, a maintenance cost, and a risk cost).
Installation cost; transient cost
Maintenance cost; cost according to the passage of time and a load power value
Risk cost; (large) damage cost when system goes down.
   IV. Reinforcement learning reward; (reward)=(reward bias)-(operation cost)
A reinforcement learning action is selected regularly from facility strategy selection options (expansion, disposal, and nothing is performed) for each transformer.
   V. A demand load curve corresponds to data for Y years.
   VI. Specifications of an electric power generator and a line correspond to an IEEE model.
   VII. Evaluation (inference); a facility change plan corresponding to electric power demand data for the year following the Y years is established.

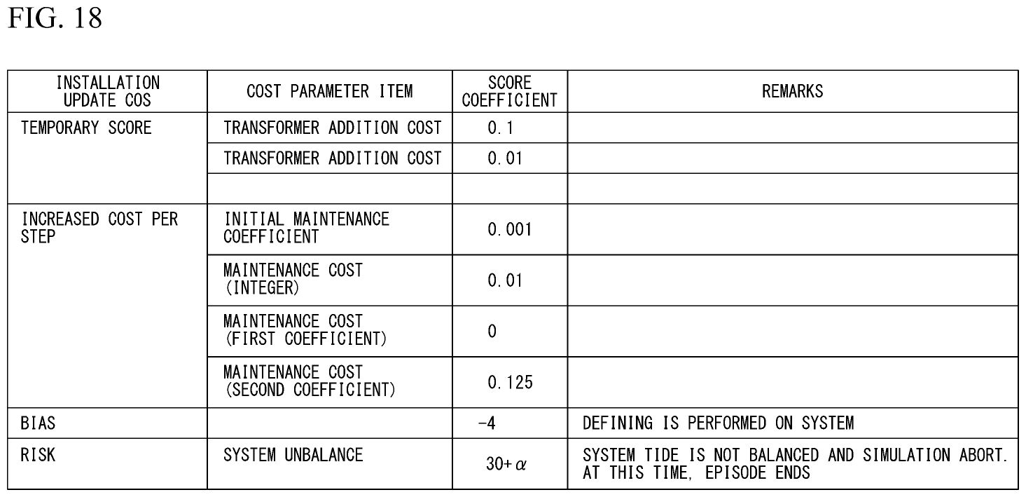

FIG. 18 is a diagram illustrating an example of costs of disposal, new installation, and replacement of a facility in a facility change plan of an electric power circuit. In this way, each cost may be further classified and a cost coefficient may be set for each cost. For example, a transformer additional cost is a temporary cost and has a cost coefficient of 0.1. Furthermore, a transformer removal cost is a temporary cost and has a cost coefficient of 0.01. Such cost classification and cost coefficient setting are set in advance. The cost classification and setting may be set by a system designer, for example, on the basis of the work actually performed in the past. In the embodiment, in this way, installation costs and operation/maintenance costs for each facility are incorporated as functions.

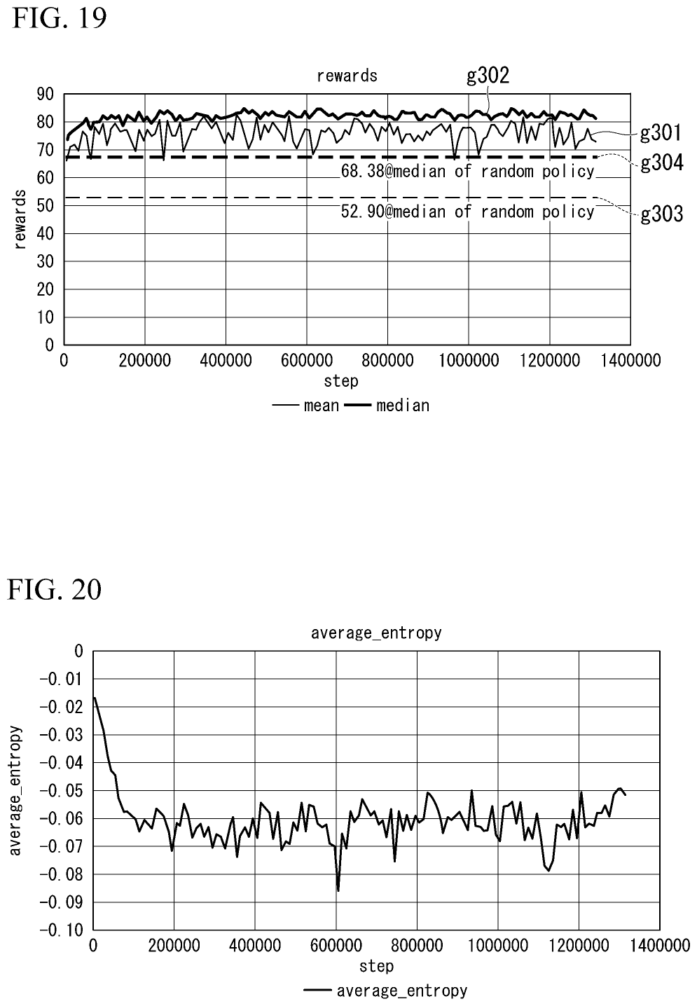

FIG. 19 illustrates a learning curve as a result of performing A3C learning on the above-described tasks. FIG. 19 is a diagram illustrating a learning curve of a facility change plan task of an electric power system. In FIG. 19, a horizontal axis indicates the number of learning update steps and a vertical axis indicates the above-described cumulative reward value. Furthermore, Reference symbol g301 corresponds to a learning curve of an average value. Reference symbol g302 corresponds to a learning curve of a median value. Reference symbol g303 corresponds to an average value of a random design for comparison. Reference symbol g304 corresponds to a median value of a random design for comparison. FIG. 19 illustrates the facility change plan which is sampled and generated on the basis of the policy function updated for each learning step and an average value and a median value of a cumulative reward value of this sample set. As illustrated in FIG. 19, it can be seen that a strategy having a higher score is obtained through learning.

FIG. 20 is a diagram illustrating an evaluation of entropy for each learning step. The entropy illustrated in FIG. 10 is a mutual entropy with a random policy in the same system configuration. In FIG. 20, a horizontal axis indicates the number of learning update steps and a vertical axis indicates an average value of an entropy. After the number of learning progress steps exceeds 100,000, an average value of an entropy is within the range of about −0.05 to −0.09.

Although the progress of the learning process can be grasped from the learning curve, the actual facility change plan proposal needs to be generated by the policy function acquired in this learning process. For this reason, 1000 plan proposals and a cumulative reward value for each plan proposal are calculated and selection criteria such as a plan proposal in which a minimum value of a cumulative reward value is realized or a plan proposal in which the top three value is extracted among minimum value cumulative reward values can be set as a selection policy from the series.

The information processing device 1 generates a plan change proposal for an examination period on the basis of the policy function and manages cumulative reward values in association with each other (for example, Planₖ: {Aₜ to π(·|Sₜ)}ₜ→Gₖ) when a plan proposal is created on the basis of a policy.

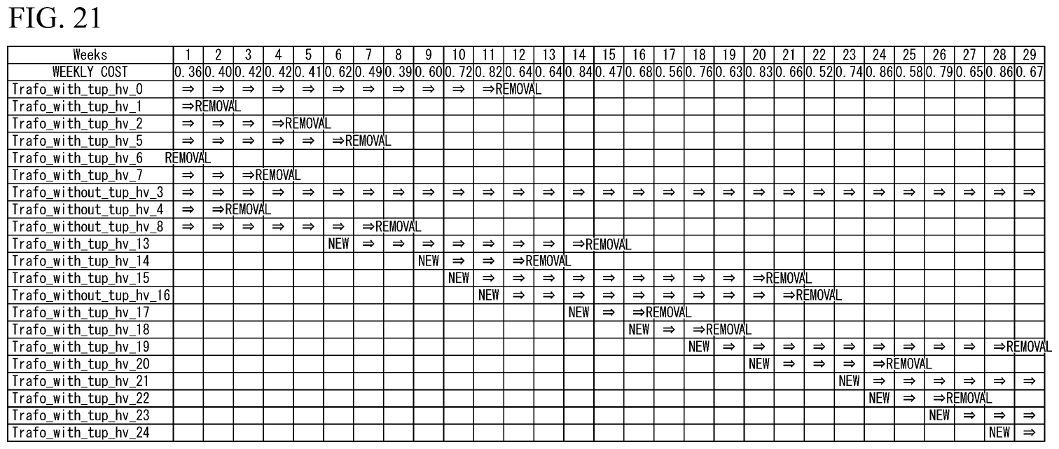

FIG. 21 is a diagram illustrating a specific plan proposal in which a cumulative cost is minimized among generated plan proposals. Each row is a separate facility node and each column indicates a timing of changes (for example, weekly). Furthermore, in FIG. 21, the expression “an arrow in a rightward direction” indicates the expression “nothing is performed” and “removal” indicates disposal or removal of a facility, and the term “new” indicates addition of a facility.

FIG. 21 illustrates a series of behaviors for each facility from an initial state 0 to 29 updating opportunities (29 weeks). A node in which 9 facilities are provided as an initial state shows a change series such as deletion and addition as the series progresses. As in the example illustrated in FIG. 21, it is easier for the user to understand that this cumulative value is smaller than that of other plan proposals by presenting the cost of the entire system at each timing.

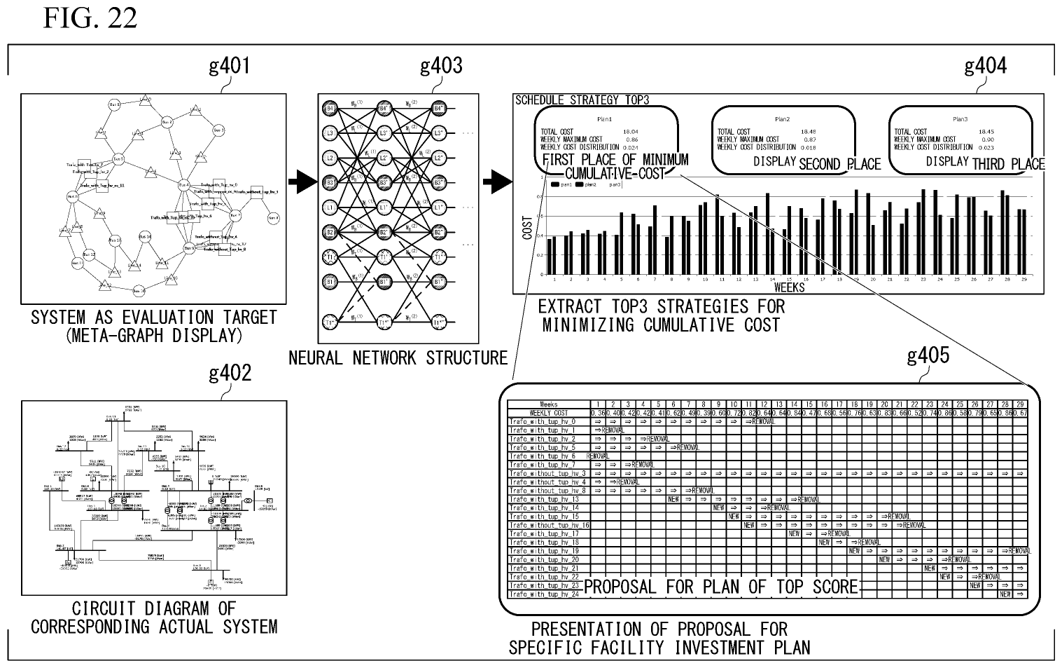

FIG. 22 is a diagram illustrating an example of an image displayed on the display device 3.

An image of reference symbol g401 is an example of an image in which an evaluation target system is represented using a meta-graph. An image of Reference symbol g402 is an image of a circuit diagram of a corresponding actual system. An image of Reference symbol g403 is an example of an image in which an evaluation target system is represented using a neural network structure. An image of Reference symbol g404 is an example of an image in which top three plans having the lowest cost among cumulative costs are represented. An image of Reference symbol g405 is an example of an image in which a specific facility change plan having the highest cumulative minimum cost is represented (for example, FIG. 21).

In this way, in the embodiment, a plan in which the conditions are satisfied and a satisfactory score is provided (a plan with a low cost) is extracted from a sample plan set. A plurality of high-ranking plans may be selected and displayed as the number of plans to be extracted as illustrated in FIG. 22. Furthermore, as a plan proposal, facility change proposals are displayed in series for each sample.

In this way, the information processing device 1 causes the display device 3 (FIG. 1) to display a meta-graph display and a plan proposal of the system. The information processing device 1 may extract a plan in which the conditions are satisfied and a satisfactory score is provided from the sample plan set and may select and display a plurality of high-ranking plans. The information processing device 1 may display, as plan proposals, facility change proposals in series for each sample. The information processing device 1 may cause setting of the environment from task setting, setting of a learning function, acquisition of a policy function through learning, an inference in which the acquired policy function is utilized, that is, formulation of a facility change plan proposal, and these situations to be displayed in accordance with the operation result when the user operates the manipulator 14. The image to be displayed may be an image such as a graph and a table.

The user may adopt an optimum plan proposal according to the environment and the situation by checking the displayed image, graph, or the like of the plan proposal and cost.

Extraction filters of leveling, a parameter change, and the like will be described below. The information processing device 1 may utilize the extraction filters of leveling, a parameter change, and the like in the optimum plan extraction.

In a first extraction example, a plan proposal in which a setting level of leveling is satisfied is prepared from a set M. In a second extraction example, a plan proposal is created by changing a coefficient of a cost function. In the second extraction example, for example, coefficient dependence is evaluated. In a third extraction example, a plan proposal is created by changing an initial state of each facility. In the third extraction example, for example, initial state dependence (an aging history at the beginning of the examination period and the like) is evaluated.

According to at least one embodiment described above, when the convolution function management function unit, the meta-graph structure series management function unit, the neural network management function unit, and the reinforcement learner are provided, it is possible to create a social infrastructure change proposal.

Also, according to at least one embodiment described above, it is possible to perform higher speed processing by evaluating a combination of the connected node and candidate node through parallel processing using the neural network obtained by connecting the candidate node to the system.

Furthermore, according to at least one embodiment described above, since the plan proposal with a satisfactory score is presented on the display device 3, it is easier for user to examine a plan proposal.

The function units of the neural network generator 100 and the information processing device 1 are realized when a hardware processor such as a central processing unit (CPU) executes a program (software). Some or all of these constituent elements may be implemented through hardware (including a circuit unit; a circuitry) such as a large scale integration (LSI), an application specific integrated circuit (ASIC), a field-programmable gate array (FPGA), a graphics processing unit (GPU) or may be implemented through cooperation of software and hardware. The program may be stored in advance in a storage device such as a hard disk drive (HDD) and a flash memory, stored in an attachable/detachable storage medium such as a DVD and a CD-ROM, or installed when a storage medium is installed in a drive device.

Although some embodiments of the present invention have been described, these embodiments are presented as examples and are not intended to limit the scope of the present invention. These embodiments can be implemented in various other forms and various omissions, replacements, and changes are possible without departing from the gist of the present invention. These embodiments and modifications thereof are included in the scope and the gist of the present invention and the invention described in the claims and the equivalent scope thereof.

### EXPLANATION OF REFERENCES

100 Neural network generator
1 Information processing device
11 Management function unit
12 Graph convolution neural network
13 Reinforcement learner
14 Manipulator
15 Image processor
16 Presenter
111 Meta-graph structure series management function unit
112 Convolution function management function unit
113 Neural network management function unit
2 Environment
3 Display device
S State of system
S′ New state of system
A action

What is claimed is:

1. An information processing device, comprising:
a definer configured to associate a node and an edge with attributes and to define a convolution function associated with a model representing data of a graph structure representing a system structure on the basis of data regarding the graph structure;
an evaluator configured to input a state of the system into the model, the evaluator being configured to obtain, for each time step, a policy function as a probability distribution of a structural change and a state value function for reinforcement learning for a system of one or more structurally changed models which have been changed with assumable structural changes from the model for each time step, and the evaluator being configured to evaluate the structural changes in the system on the basis of the policy function; and
a reinforcement learner configured to perform reinforcement learning by using a reward value as a cost generated when the structural change is applied to the system, the state value function, and the model, to optimize the structural change in the system.

2. The information processing device according to claim 1, wherein the definer is configured to define a respective convolution function for each type of facility included in the system.

3. The information processing device according to claim 1, wherein the reinforcement learner is configured to output a set of parameters as coefficients of the convolution function obtained as a result of the reinforcement learning to the definer,
the definer is configured to update the set of parameters of the convolution function on the basis of the set of parameter output by the reinforcement learner, and
the evaluator is configured to reflect the updated set of parameters in the model and to evaluate the model obtained by reflecting the updated set of parameters.

4. The information processing device according to claim 1, wherein the definer is configured to incorporate a candidate for the structural change as a candidate node into the graph structure in the system and to configure the candidate node as the convolution function of a unidirectional connection, and
the evaluator is configured to configure the model using the convolution function of the unidirectional connection.

5. The information processing device according to claim 4, wherein the evaluator is configured to evaluate, by parallel processing, the model for each combination of the candidate node with a node connected to the candidate node, using the model in which the candidate node is connected to the graph structure.

6. The information processing device according to claim 1, further comprising:
a presenter configured to present a structural change of the system evaluated by the evaluator, together with a cost associated with the structural change of the system.

7. A computer-implemented method for processing information by one or more hardware device, the method comprising:
associating a node and an edge with attributes;
defining a convolution function associated with a model representing data of a graph structure representing a system structure on the basis of data regarding the graph structure;
inputting a state of the system into the model;
obtaining, for each time step, a policy function as a probability distribution of a structural change and a state value function for reinforcement learning for a system of one or more structurally changed models which have been changed with assumable structural changes from the model for each time step, and the evaluator being configured;
evaluating the structural changes in the system on the basis of the policy function; and
performing reinforcement learning by using a reward value as a cost generated when the structural change is applied to the system, the state value function, and the model, to optimize the structural change in the system.

8. A non-transitory computer-readable storage medium that stores computer-executable instructions that cause one or more computers, when executed by the one or more computers, to at least:
associate a node and an edge with attributes;
define a convolution function associated with a model representing data of a graph structure representing a system structure on the basis of data regarding the graph structure;
input a state of the system into the model;
obtain, for each time step, a policy function as a probability distribution of a structural change and a state value function for reinforcement learning for a system of one or more structurally changed models which have been changed with assumable structural changes from the model for each time step, and the evaluator being configured;
evaluate the structural changes in the system on the basis of the policy function; and
perform reinforcement learning by using a reward value as a cost generated when the structural change is applied to the system, the state value function, and the model, to optimize the structural change in the system.
